(19) United States
(12) Patent Application Publication
(10) Pub. No.: US 2013/0295290 A1
(43) Pub. Date: Nov. 7, 2013

(54) COMPOSITIONS WITH A SULFUR-CONTAINING POLYMER AND GRAPHENIC CARBON PARTICLES

(71) Applicants: Lawrence G. Anderson, Allison Park, PA (US); David B. Asay, Sarver, PA (US); Cheng-Hung Hung, Wexford, PA (US); Noel R. Vanier, Wexford, PA (US)

(72) Inventors: Lawrence G. Anderson, Allison Park, PA (US); David B. Asay, Sarver, PA (US); Cheng-Hung Hung, Wexford, PA (US); Noel R. Vanier, Wexford, PA (US)

(73) Assignee: PPG Industries Ohio, Inc., Cleveland, OH (US)

(21) Appl. No.: 13/463,086

(22) Filed: May 3, 2012

(51) Int. Cl. C08L 81/02; B05D 7/24; B05D 3/00; C08K 3/04; H01B 1/24; B82Y 30/00

(52) U.S. Cl. 427/385.5; 524/609; 252/511; 977/773

(57) ABSTRACT

Disclosed are compositions, such as sealant compositions, that include a sulfur-containing polymer and graphenic carbon particles.

### FIELD

The present invention relates to compositions, such as sealant compositions, that include a sulfur-containing polymer and graphenic carbon particles, as well as methods for using such compositions.

### BACKGROUND

Sulfur-containing polymers are known to be well-suited for use in various applications, such as aerospace sealant compositions, due, in large part, to their fuel-resistant nature upon cross-linking. Exemplary sulfur-containing polymers used in aerospace sealant compositions are polysulfides, which are polymers that contain —S—S— linkages, and polythioethers, which are polymers that contain —C—S—C— linkages.

In some applications, it is important to impart electrical conductivity and/or electromagnetic interference/radio frequency interference (EMI/RFI) shielding effectiveness to such aerospace sealant compositions. This is often done by incorporating conductive materials within the polymer matrix. Electrically conductive metal-based fillers, such as Ni-containing fillers, have often been used for this purpose. To achieve the required properties, however, relatively high loadings of such metal-based fillers have often been required, which raises undesirable toxicity and environmental disadvantages. Moreover, these fillers are relatively dense materials, which can significantly increase the weight of the composition. This increased weight is often undesirable in aerospace sealant applications. Other electrically conductive fillers, such as carbon nanotubes and electrically conductive carbon black, are either prohibitively expensive when used in large amounts and/or are of limited effectiveness on their own.

### SUMMARY OF THE INVENTION

In certain respects, the present invention is directed to compositions comprising: (i) a sulfur-containing polymer; and (ii) graphenic carbon particles.

The present invention is also directed to, inter alia, methods for using such compositions.

### BRIEF DESCRIPTION OF THE DRAWINGS

FIG. 1 is a plot of Raman shift versus intensity for a sample of the material produced according to Example 1.

FIG. 2 is a TEM micrograph of a sample of the material produced according to Example 1.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As indicated above, certain embodiments of the present invention are directed to compositions, such as sealant compositions. As used herein, the term “sealant composition” refers to a composition that, when applied to an aperture (such as the joint or space formed by the interface between two parts), has the ability to resist atmospheric conditions, such as moisture and temperature, and at least partially block the transmission of materials, such as water, fuel, and/or other liquids and gasses, which might otherwise occur at the aperture. Sealants compositions, therefore, are often applied to a peripheral edge surface of a component part for the purpose of hindering material transport to or from such a part. Sealants often have adhesive properties, but are not simply adhesives that do not have the blocking properties of a sealant.

The compositions of the present invention can be deposited upon any of a variety of substrates. In certain embodiments, however, the substrate is electrically conductive, such as is the case with substrates comprising titanium, stainless steel, aluminum, as well as electrically conductive composite materials, such as polymeric materials containing a sufficient amount of conductive filler.

The compositions of the present invention comprise a sulfur-containing polymer, which, as used herein, refers to a polymer that contains multiple sulfide groups, i.e., —S—, in the polymer backbone and/or in the terminal or pendant positions on the polymer chain. In certain embodiments, the sulfur-containing polymer present in the compositions of the present invention comprises at least one of a polysulfide and a polythioether.

As used herein, the term “polysulfide” refers to a polymer that contains one or more disulfide linkages, i.e., —[S—S]— linkages, in the polymer backbone and/or in the terminal or pendant positions on the polymer chain. Often, the polysulfide polymer will have two or more sulfur-sulfur linkages. Suitable polysulfides include, for example, those that are commercially available from Akzo Nobel under the name THIOPLAST. THIOPLAST products are available in a wide range of molecular weights ranging, for example, from less than 1100 to over 8000, with molecular weight being the average molecular weight in grams per mole. In some cases, the polysulfide has a number average molecular weight of 1,000 to 4,000. The crosslink density of these products also varies, depending on the amount of crosslinking agent, such as trichloropropane, used. For example, crosslink densities often range from 0 to 5 mol %, such as 0.2 to 5 mol %. The “—SH” content, i.e., mercaptan content, of these products can also vary. The mercaptan content and molecular weight of the polysulfide can affect the cure speed of the polymer, with cure speed increasing with molecular weight. Suitable polysulfides are also disclosed in U.S. Pat. No. 2,466,963, the entire content of which being incorporated herein by reference.

In some embodiments of the present invention, the composition comprises a mixture of two or more polysulfides. For example, in some embodiments, the composition comprises a polymeric mixture comprising: (a) from 90 mole percent to 25 mole percent of mercaptan terminated disulfide polymer of the formula HS(RSS)ₘR′SH; and (b) from 10 mole percent to 75 mole percent of diethyl formal mercaptan terminated polysulfide polymer of the formula HS(RSS)ₙRSH, wherein R is —C₂H₄—O—CH₂—O—C₂H₄—; R′ is a divalent member selected from alkyl of from 2 to 12 carbon atoms, alkyl thioether of from 4 to 20 carbon atoms, alkyl ether of from 4 to 20 carbon atoms and one oxygen atom, alkyl ether of from 4 to 20 carbon atoms and from 2 to 4 oxygen atoms each of which is separated from the other by at least 2 carbon atoms, alicyclic of from 6 to 12 carbon atoms, and aromatic lower alkyl; and the value of m and n is such that the diethyl formal mercaptan terminated polysulfide polymer and the mercaptan terminated disulfide polymer have an average molecular weight of from 1,000 to 4,000, such as 1,000 to 2,500. Such polymeric mixtures are described in U.S. Pat. No. 4,623,711 at col. 4, line 18 to col. 8, line 35, the cited portion of which being incorporated herein by reference. In some cases, R′ in the above formula is —CH₂—CH₂—; —C₂H₄—O—C₂H₄—; —C₂H₄—S—C₂H₄—; —C₂H₄—O—C₂H₄—O—C₂H₄—; or —CH₂—C₆H₄—CH₂—. Such polysulfide mixtures are commercially available from PRC-Desoto International, Inc., under the trademark PERMAPOL, such as PERMAPOL P-5.

In addition to or in lieu of a polysulfide, the compositions of the present invention may comprise one or more polythioethers. As used herein, the term “polythioether” refers to a polymer comprising at least one thioether linkage, i.e., —[—C—S—C—]—, in the polymer backbone and/or in the terminal or pendant positions on the polymer chain. Often, polythioethers have from 8 to 200 of these linkages. Polythioethers suitable for use in the present invention include, for example, those having repeating units or groups of the formula (I):

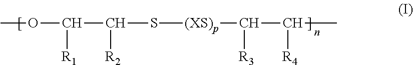

in which X is (CH₂)₂, (CH₂)₄, (CH₂)₂S(CH₂)₂, or (CH₂)₂O(CH₂)₂, n is 8 to 200, p is 0 or 1; and each of R₁, R₂, R₃, and R₄ is H or lower (C₁-C₄) alkyl, such as methyl. Such polythioethers are described in U.S. Pat. No. 4,366,307 at col. 2, line 6 to col. 11, line 52, the cited portion of which being incorporated herein by reference.

In certain embodiments of the present invention, the composition comprises one or more polythioethers that include a structure having the formula (II):

—R¹—[—S—(CH₂)₂—O—[—R²—O—]ₘ—(CH₂)₂—S—R¹]ₙ— (II)

wherein: (1) R¹ denotes a C₂₋₆ n-alkylene, C₃₋₆ branched alkylene, C₆₋₈ cycloalkylene or C₆₋₁₀ alkylcycloalkylene group, —[(—CH₂—)ₚ—X—]_{q}—(—CH₂—)ᵣ—, or —[(—CH₂—)ₚ—X—]_{q}—(—CH₂—)ᵣ— in which at least one —CH₂— unit is substituted with a methyl group; (2) R² denotes a C₂₋₆ n-alkylene, C₂₋₆ branched alkylene, C₆₋₈ cycloalkylene or C₆₋₁₀ alkylcycloalkylene group, or —[(—CH₂—)ₚ—X—]_{q}—(—CH₂—)ᵣ—, X denotes one selected from the group consisting of O, S and —NR⁶—, R⁶ denotes H or methyl; (3) m is a rational number from 0 to 10; (4) n is an integer from 1 to 60; (5) p is an integer from 2 to 6; (6) q is an integer from 1 to 5, and (7) r is an integer from 2 to 10. Such polythioethers are described in U.S. Pat. No. 6,172,179 at col. 2, line 29 to col. 4, line 34 and col. 5, line 42 to col. 12, line 22, the cited portions of which being incorporated herein by reference. Examples of suitable polythioethers include, but are not limited to, those available from PRC-Desoto International, Inc., under the trademark PERMAPOL, such as PERMAPOL L56086, P-3.1e and PERMAPOL P-3.

In certain embodiments of the present invention, the composition may comprise a polymer blend comprising: (a) a polysulfide as described above and (b) a polythioether that includes a structure having the formula (II). In some embodiments, the weight ratio of (a) and (b) in such polymer blends is 10:90 to 90:10, such as 50:50. Such polymer blends are described in U.S. Pat. No. 7,524,564 at col. 1, lines 51 to col. 2, line 67, the cited portion of which being incorporated herein by reference.

In certain compositions of the present invention, the sulfur-containing polymer is terminated with non-reactive groups, such as alkyl groups. In other embodiments, however, the sulfur-containing polymer contains reactive functional groups in the terminal and/or pendant positions. Exemplary such reactive groups include, but are not limited to, thiol, hydroxyl, isocyanate, epoxy, amino, silyl, and silane groups. In some embodiments, the sulfur-containing polymer is cured with a curing agent that is reactive with the reactive groups of the sulfur-containing polymer.

Sulfur-containing polymers of the present disclosure can have number average molecular weights ranging from 500 to 8,000 grams per mole, and in certain embodiments, from 1,000 to 5,000 grams per mole, as determined by gel permeation chromatography using a polystyrene standard. For sulfur-containing polymers that contain reactive functional groups, the sulfur-containing polymers can have average functionalities ranging from, for example, 2.05 to 3.0, and in certain embodiments ranging from 2.1 to 2.6. A specific average functionality can be achieved by suitable selection of reactive components, including polyfunctionalizing agents.

In certain embodiments, the sulfur-containing polymer is present in the composition in an amount of at least 30 weight percent, such as least 40 weight percent, or, in some cases, at least 45 weight percent, based on the total weight of non-volatile components in the composition. In certain embodiments, the sulfur-containing polymer is present in the composition in an amount of no more than 90 weight percent, such as no more than 80 weight percent, or, in some cases, no more than 75 weight percent, based on the weight of all non-volatile components of the composition.

In certain embodiments, the compositions of the present invention also comprise a curing agent. As used herein, “curing agent” refers to any material that can be added to a sulfur-containing polymer to accelerate the curing or gelling of the sulfur-containing polymer. In certain embodiments, the curing agent is reactive at a temperature ranging from 10° C. to 80° C. The term “reactive” means capable of chemical reaction and includes any level of reaction from partial to complete reaction of a reactant. In certain embodiments, a curing agent is reactive when it provides for cross-linking or gelling of a sulfur-containing polymer.

In certain embodiments, the compositions of the present invention comprise a curing agent that comprises an oxidizing agent capable of oxidizing terminal mercaptan groups of the sulfur-containing polymer to form disulfide bonds. Useful oxidizing agents include, for example, lead dioxide, manganese dioxide, calcium dioxide, sodium perborate monohydrate, calcium peroxide, zinc peroxide, and dichromate. Additives such as sodium stearate can also be included to improve the stability of the accelerator.

In certain embodiments, the compositions of the present invention comprise a curing agent containing functional groups reactive with functional groups attached to the sulfur-containing polymer. Useful curing agents include polythiols, such as thiol-functional polythioethers, for curing vinyl-terminated polymers; polyisocyanates such as isophorone diisocyanate, hexamethylene diisocyanate, and mixtures and isocyanurate derivatives thereof for curing thiol-, hydroxyl- and amino-terminated polymers; and, polyepoxides for curing amine- and thiol-terminated polymers. The term “polyepoxide” refers to a material having a 1,2-epoxy equivalent greater than one and includes monomers, oligomers, and polymers. Polyepoxide curing agents useful in certain compositions of the invention (particularly in the case in which a thiol-functional sulfur-containing polymer is used) include, for example, hydantoin diepoxide, diglycidyl ether of bisphenol-A, diglycidyl ether of bisphenol-F, Novolac type epoxides, and any of the epoxidized unsaturated and phenolic resins.

The compositions of the present invention comprise graphenic carbon particles. As used herein, the term “graphenic carbon particles” means carbon particles having structures comprising one or more layers of one-atom-thick planar sheets of sp²-bonded carbon atoms that are densely packed in a honeycomb crystal lattice. The average number of stacked layers may be less than 100, for example, less than 50. In certain embodiments, the average number of stacked layers is 30 or less, such as 20 or less, 10 or less, or, in some cases, 5 or less. The graphenic carbon particles may be substantially flat, however, at least a portion of the planar sheets may be substantially curved, curled, creased or buckled. The particles typically do not have a spheroidal or equiaxed morphology.

In certain embodiments, the graphenic carbon particles present in the compositions of the present invention have a thickness, measured in a direction perpendicular to the carbon atom layers, of no more than 10 nanometers, no more than 5 nanometers, or, in certain embodiments, no more than 4 or 3 or 2 or 1 nanometers, such as no more than 3.6 nanometers. In certain embodiments, the graphenic carbon particles may be from 1 atom layer up to 3, 6, 9, 12, 20 or 30 atom layers thick, or more. In certain embodiments, the graphenic carbon particles present in the compositions of the present invention have a width and length, measured in a direction parallel to the carbon atoms layers, of at least 50 nanometers, such as more than 100 nanometers, in some cases more than 100 nanometers up to 500 nanometers, or more than 100 nanometers up to 200 nanometers. The graphenic carbon particles may be provided in the form of ultrathin flakes, platelets or sheets having relatively high aspect ratios (aspect ratio being defined as the ratio of the longest dimension of a particle to the shortest dimension of the particle) of greater than 3:1, such as greater than 10:1.

In certain embodiments, the graphenic carbon particles used in the compositions of the present invention have relatively low oxygen content. For example, the graphenic carbon particles used in certain embodiments of the compositions of the present invention may, even when having a thickness of no more than 5 or no more than 2 nanometers, have an oxygen content of no more than 2 atomic weight percent, such as no more than 1.5 or 1 atomic weight percent, or no more than 0.6 atomic weight, such as about 0.5 atomic weight percent. The oxygen content of the graphenic carbon particles can be determined using X-ray Photoelectron Spectroscopy, such as is described in D. R. Dreyer et al., Chem. Soc. Rev. 39, 228-240 (2010).

In certain embodiments, the graphenic carbon particles used in the compositions of the present invention have a relatively low bulk density, which can be particularly useful in aerospace sealant applications where weight reduction is desired. For example, the graphenic carbon particles used in certain embodiments of the present invention are characterized by having a bulk density (tap density) of less than 0.2 g/cm³, such as no more than 0.1 g/cm³. For the purposes of the present invention, the bulk density of the graphenic carbon particles is determined by placing 0.4 grams of the graphenic carbon particles in a glass measuring cylinder having a readable scale. The cylinder is raised approximately one-inch and tapped 100 times, by striking the base of the cylinder onto a hard surface, to allow the graphenic carbon particles to settle within the cylinder. The volume of the particles is then measured, and the bulk density is calculated by dividing 0.4 grams by the measured volume, wherein the bulk density is expressed in terms of g/cm³.

In certain embodiments, the graphenic carbon particles used in the compositions of the present invention have a B.E.T. specific surface area of at least 50 square meters per gram, such as 70 to 1000 square meters per gram, or, in some cases, 200 to 1000 square meters per grams or 200 to 400 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

In certain embodiments, the graphenic carbon particles used in the compositions of the present invention have a Raman spectroscopy 2D/G peak ratio of at least 1.1. As used herein, the term “2D/G peak ratio” refers to the ratio of the intensity of the 2D peak at 2692 cm⁻¹ to the intensity of the G peak at 1,580 cm⁻¹.

In certain embodiments, the graphenic carbon particles used in the compositions of the present invention have a compressed density and a percent densification that is less than the compressed density and percent densification of graphite powder and certain types of substantially flat graphenic carbon particles. Lower compressed density and lower percent densification are each currently believed to contribute to better dispersion and/or rheological properties than graphenic carbon particles exhibiting higher compressed density and higher percent densification. In certain embodiments, the compressed density of the graphenic carbon particles is 0.9 or less, such as less than 0.8, less than 0.7, such as from 0.6 to 0.7. In certain embodiments, the percent densification of the graphenic carbon particles is less than 40%, such as less than 30%, such as from 25 to 30%.

For purposes of the present invention, the compressed density of graphenic carbon particles is calculated from a measured thickness of a given mass of the particles after compression. Specifically, the measured thickness is determined by subjecting 0.1 grams of the graphenic carbon particles to cold press under 15,000 pound of force in a 1.3 centimeter die for 45 minutes (contact pressure=500 MPa [Mega-Pascal] pressure). The compressed density of the graphenic carbon particles is then calculated from this measured thickness according to the following equation:

$$Compressed Density ( g \text{/} {cm}^{3} ) = \frac{0.1 grams}{Π * {( 1.3 cm \text{/} 2 )}^{2} * ( measured thickness in cm )}$$

The percent densification of the graphenic carbon particles is then determined as the ratio of the calculated compressed density of the graphenic carbon particles, as determined above, to 2.2 g/cm³, which is the density of graphite.

In certain embodiments, the graphenic carbon particles have a measured bulk liquid conductivity of at least 100 microSiemens, such as at least 120 microSiemens, such as at least 140 microSiemens immediately after mixing and at later points in time, such as at 10 minutes, or 20 minutes, or 30 minutes, or 40 minutes. For the purposes of the present invention, the bulk liquid conductivity of the graphenic carbon particles is determined as follows. First, a sample comprising 0.5% solution of graphenic carbon particles in butyl cellosolve is sonicated for 30 minutes with a bath sonicator. Immediately following sonication, the sample is placed in a standard calibrated electrolytic conductivity cell (K=1). A Fisher Scientific AB 30 conductivity meter is introduced to the sample to measure the conductivity of the sample. The conductivity is plotted over the course of about 40 minutes.

The graphenic carbon particles utilized in the compositions of the present invention can be made, for example, by thermal processes. In accordance with embodiments of the invention, the graphenic carbon particles are produced from carbon-containing precursor materials that are heated to high temperatures in a thermal zone. For example, the graphenic carbon particles may be produced by the systems and methods disclosed in U.S. patent application Ser. Nos. 13/249,315 and 13/309,894.

In certain embodiments, the graphenic carbon particles may be made by using the apparatus and method described in U.S. patent application Ser. No. 13/249,315 at [0022] to [0048], the cited portion of which being incorporated herein by reference, in which (i) one or more hydrocarbon precursor materials capable of forming a two-fragment species (such as n-propanol, ethane, ethylene, acetylene, vinyl chloride, 1,2-dichloroethane, allyl alcohol, propionaldehyde, and/or vinyl bromide) is introduced into a thermal zone (such as a plasma); and (ii) the hydrocarbon is heated in the thermal zone to a temperature of at least 1,000° C. to form the graphenic carbon particles. In addition, the graphenic carbon particles can be made by using the apparatus and method described in U.S. patent application Ser. No. 13/309,894 at [0015] to [0042], the cited portion of which being incorporated herein by reference, in which (i) a methane precursor material (such as a material comprising at least 50 percent methane, or, in some cases, gaseous or liquid methane of at least 95 or 99 percent purity or higher) is introduced into a thermal zone (such as a plasma); and (ii) the methane precursor is heated in the thermal zone to form the graphenic carbon particles. Such methods can produce graphenic carbon particles having at least some, in some cases all, of the characteristics described above.

During production of the graphenic carbon particles by the methods described above, a carbon-containing precursor is provided as a feed material that may be contacted with an inert carrier gas. The carbon-containing precursor material may be heated in a thermal zone, for example, by a plasma system. In certain embodiments, the precursor material is heated to a temperature ranging from 1,000° C. to 20,000° C., such as 1,200° C. to 10,000° C. For example, the temperature of the thermal zone may range from 1,500 to 8,000° C., such as from 2,000 to 5,000° C. Although the thermal zone may be generated by a plasma system, it is to be understood that any other suitable heating system may be used to create the thermal zone, such as various types of furnaces including electrically heated tube furnaces and the like.

The gaseous stream may be contacted with one or more quench streams that are injected into the plasma chamber through at least one quench stream injection port. The quench stream may cool the gaseous stream to facilitate the formation or control the particle size or morphology of the graphenic carbon particles. In certain embodiments of the invention, after contacting the gaseous product stream with the quench streams, the ultrafine particles may be passed through a converging member. After the graphenic carbon particles exit the plasma system, they may be collected. Any suitable means may be used to separate the graphenic carbon particles from the gas flow, such as, for example, a bag filter, cyclone separator or deposition on a substrate.

Without being bound by any theory, it is currently believed that the foregoing methods of manufacturing graphenic carbon particles are particularly suitable for producing graphenic carbon particles having relatively low thickness and relatively high aspect ratio in combination with relatively low oxygen content, as described above. Moreover, such methods are currently believed to produce a substantial amount of graphenic carbon particles having a substantially curved, curled, creased, or buckled morphology (referred to herein as a “3D” morphology), as opposed to producing predominantly particles having a substantially two-dimensional (or flat) morphology. This characteristic is believed to be reflected in the previously described compressed density characteristics and is believed to be beneficial in the sealant composition applications of the present invention because, it is currently believed, when a significant portion of the graphenic carbon particles have a 3D morphology, “edge to edge” and “edge to face” contact between graphenic carbon particles within the composition may be promoted. This is thought to be because particles having a 3D morphology are less likely to be aggregated in the composition (due to lower Van der Waals forces) than particles having a two-dimensional morphology. Moreover, it is currently believed that even in the case of “face to face” contact between the particles having a 3D morphology, since the particles may have more than one facial plane, the entire particle surface is not engaged in a single “face to face” interaction with another single particle, but instead can participate in interactions with other particles, including other “face to face” interactions, in other planes. As a result, graphenic carbon particles having a 3D morphology are currently thought to provide the best conductive pathway in the present compositions and is currently thought to be useful for obtaining electrical conductivity characteristics sought by the present invention, particularly when the graphenic carbon particles are present in the composition in the relatively low amounts described below.

In certain embodiments, the graphenic carbon particles are present in the compositions of the present invention in an amount of at least 0.1 weight percent, such as least 1 weight percent, or, in some cases, at least 2 weight percent, based on the total weight of non-volatile components in the composition. In certain embodiments, the graphenic carbon particles are present in the compositions of the present invention in an amount of no more than 30 weight percent, such as no more than 20 weight percent, or, in some cases, no more than 15 weight percent, based on the weight of all non-volatile components of the composition.

In certain embodiments, the compositions of the present invention comprise other fillers besides the graphenic carbon particles described above. As used herein, “filler” refers to a non-reactive component in the composition that provides a desired property, such as, for example, electrical conductivity, density, viscosity, mechanical strength, EMI/RFI shielding effectiveness, and the like.

Fillers used to impart electrical conductivity and EMI/RFI shielding effectiveness can be used in combination with the graphenic carbon particles described above in the compositions of the present invention. Examples of such electrically conductive fillers include electrically conductive noble metal-based fillers; noble metal-plated noble metals; noble metal-plated non-noble metals; noble-metal plated glass, plastic or ceramics; noble-metal plated mica; and other noble-metal conductive fillers. Non-noble metal-based materials can also be used and include, for example, non-noble metal-plated non-noble metals; non-noble metals; non-noble-metal-plated-non metals. Such materials are described in United States Patent Application Publication No. 2004/0220327A1 at [0031], the cited portion of which being incorporated herein by reference.

Electrically conductive non-metal fillers, such as carbon nanotubes, carbon fibers (such as graphitized carbon fibers), and electrically conductive carbon black, can also be used in the compositions of the present invention in combination with the graphenic carbon particles. An example of graphitized carbon fiber suitable for use in the compositions of the present invention is PANEX 3OMF (Zoltek Companies, Inc., St. Louis, Mo.), a 0.921 micron diameter round fiber having an electrical resistivity of 0.00055 Ω-cm. Examples of electrically conductive carbon black suitable for use in the compositions of the present invention include Ketjen Black EC-600 JD (Akzo Nobel, Inc., Chicago, Ill.), an electrically conductive carbon black characterized by an iodine absorption of 1000-11500 mg/g (J0/84-5 test method), and a pore volume of 480-510 cm³/100 gm (DBP absorption, KTM 81-3504) and BLACK PEARLS® 2000 and REGAL® 660R (Cabot Corporation, Boston, Mass.). In certain embodiments, the composition comprises carbon nanotubes having a length dimension ranging from 5 μm to 30 μm, and a diameter dimension ranging from 10 nanometers to 30 nanometers. In some embodiments, for example, the carbon nanotubes have dimensions of 11 nanometers by 10 μm.

In certain embodiments of the present invention, therefore, the composition comprises both graphenic carbon particles and electrically conductive carbon black. In certain of these embodiments, the graphenic carbon particles and the electrically conductive carbon black are present in the composition in a relative weight ratio of 1:1 to 1:5.

In certain embodiments, the compositions of the present invention are substantially free of metal-based fillers, such as Ni-containing fillers. As used herein, the term “substantially free” means that the composition comprises no more than 5 percent by weight of such metal-based filler, such as no more than 1 percent by weight, or, in some cases, no more than 0.1 percent by weight, based on the total weight of the non-volatiles in the composition. In some cases, the compositions of the present invention are completely free of such metal-based fillers, such as Ni-containing fillers.

The compositions of the present invention may also comprise any of a variety of optional ingredients, such as electrically non-conductive fillers, corrosion inhibitors, plasticizers, organic solvents, and adhesion promoters. Such ingredients are described in more detail in United States Patent Application Publication No. 2004/0220327 A1 at [0030] and [0037]400401, the cited portion of which being incorporated herein by reference.

The Examples herein describe suitable methods for making the compositions of the present invention. In certain embodiments, for example, a base composition can be prepared by batch mixing at least one sulfur-containing polymer, additives, and/or fillers in a double planetary mixer under vacuum. Other suitable mixing equipment includes a kneader extruder, sigma mixer, or double “A” arm mixer. For example, a base composition can be prepared by mixing at least one sulfur-containing polymer, plasticizer, and phenolic adhesion promoter. After the mixture is thoroughly blended, additional constituents can be separately added and mixed using a high shear grinding blade, such as a Cowless blade, until cut in. Examples of additional constituents that can be added to the base composition include the graphenic carbon particles, other conductive fillers (such as carbon nanotubes, stainless steel fibers, and conductive carbon black), corrosion inhibitors, non-conductive fillers, and adhesion promoters.

A curing agent composition can be prepared by batch mixing a curing agent, additives, and fillers. The base composition and curing agent composition can then be mixed together to form the sealant composition, which can then be applied to a substrate.

These and other aspects of the claimed invention are further illustrated by the following non-limiting examples.

### EXAMPLES

### Example 1

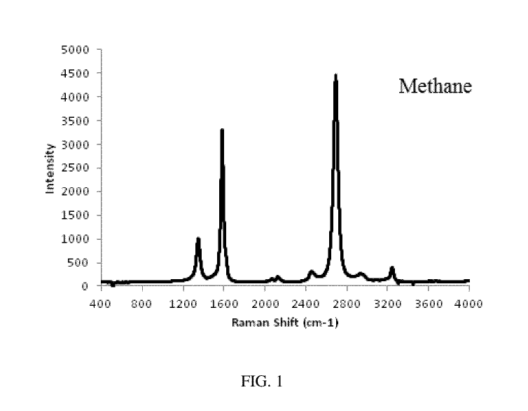

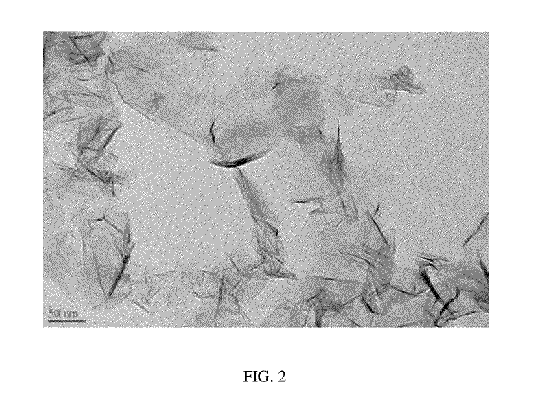

Graphenic carbon particles were produced using a DC thermal plasma reactor system. The main reactor system included a DC plasma torch (Model SG-100 Plasma Spray Gun commercially available from Praxair Technology, Inc., Danbury, Conn.) operated with 60 standard liters per minute of argon carrier gas and 26 kilowatts of power delivered to the torch. Methane precursor gas, commercially available from Airgas Great Lakes, Independent, Ohio, was fed to the reactor at a rate of 5 standard liters per minute about 0.5 inch downstream of the plasma torch outlet. Following a 14 inch long reactor section, a plurality of quench stream injection ports were provided that included 6⅛ inch diameter nozzles located 60° apart radially. Quench argon gas was injected through the quench stream injection ports at a rate of 185 standard liters per minute. The produced particles were collected in a bag filter. The total solid material collected was 75 weight percent of the feed material, corresponding to a 100 percent carbon conversion efficiency. Analysis of particle morphology using Raman analysis and high resolution transmission electron microscopy (TEM) indicates the formation of a graphenic layer structure with average thickness of less than 3.6 nm. The Raman plot shown in FIG. 1 demonstrates that graphenic carbon particles were formed by virtue of the sharp and tall peak at 2692 on the plot versus shorter peaks at 1348 and 1580. The TEM image of FIG. 2 shows the thin plate-like graphenic particles. The measured B.E.T. specific surface area of the produced material was 270 square meters per gram using a Gemini model 2360 analyzer available from Micromeritics Instrument Corp., Norcross, Ga. Composition analysis of the produced material showed 99.5 atomic weight % carbon and 0.5 atomic weight % oxygen using X-ray Photoelectron Spectroscopy (XPS) available from Thermo Electron Corporation. The collected particles had a bulk density of about 0.05 g/cm³, a compressed density of 0.638 g/cm³ and a percent densification of 29%. The measured bulk liquid conductivity from 0-40 minutes of a 0.5% solution of the collected graphenic carbon particles in butyl cellosolve varied from 143 to 147 microSiemens.

### Example 2

Resin Mixture A was prepared first to be used in all experiments in this example. Permapol P3.1e, Permapol L56086 (commercially available from PRC-DeSoto International, Inc.), HB-40 plasticizer (commercially available from Solutia Inc.), DABCO 33LV amine catalyst (commercially available from Huntsman), and tung oil (commercially available from Alnor Oil Company, Inc.) were added to a “Max 300” (FlackTek) jar in the order and amounts listed in Table 1. These materials were mixed with a DAC 600.1 FVZ mixer (FlackTek) for 45 seconds. Resin Mixture A was then portioned into “Max 100” (FlackTek) jars and graphenic carbon particles were added on top of each sample and mixed on the DAC 600.1 FVZ mixer for 70 seconds. Samples were allowed to cool to room temperature before manganese dioxide accelerator was added and the samples were mixed again on the DAC 600.1 FVZ mixer for 35 seconds. All amounts are listed in Table 2. Mixed samples were immediately poured onto polyethylene sheets and allowed to flow out into flat pies. Samples cured for two weeks at room temperature. Resistivity measurements (Table 2) were made with a resistivity meter (Monroe Electronics, Model 291).

TABLE 1
Components of Resin Mixture A.
Resin Mixture A

| Material | Amount (g) |
|---|---|
| Permapol P-3.1e | 325.18 |
| Permapol L56086 | 87.02 |
| HB-40 | 5.25 |
| DABCO 33LV | 2.74 |
| Tung Oil | 8.42 |

TABLE 2
Components of each sample and final resistivity of the cured pie.

| | | Particles | xGnP ® Grade | | |
|---|---|---|---|---|---|
| | Resin | from | C-300 | | Resistivity |
| | Mixture | Example 1 | graphenic carbon | MnO₂ | (ohms per |
| Sample | A (g) | (g) | particles¹ (g) | (g) | square) |
| 1 | 63.67 | 0.7 | 0 | 6.37 | 10⁷ |
| 2 | 63.67 | 2.10 | 0 | 6.37 | 10⁵ |
| 3 | 63.67 | 6.37 | 0 | 6.37 | 10⁴ |
| 4 | 63.67 | 0 | 0.7 | 6.37 | 10⁸ |
| 5 | 63.67 | 0 | 2.10 | 6.37 | 10⁷ |
| 6 | 63.67 | 0 | 6.37 | 6.37 | 10⁷ |

¹Commercially available from XG Sciences, Inc. The graphenic carbon particles have a typical particle thickness of about 2 nanometers, a surface area of about 300 m²/g, an oxygen content of about 4 atomic weight percent, and a bulk density of 0.2 to 0.4 g/cm³. The measured bulk liquid conductivity from 0-40 minutes of a 0.5% solution of these particles in butyl cellosolve varied between 0.6 and 0.5 microSiemens. The measured compressed density and percent densification of these graphenic carbon particles was 1.3 g/cm³ and 59% respectively.

### Example 3

Resin Mixture A was prepared first to be used in all experiments in this example. All materials (listed in Table 3) were combined as stated in Example 2. Resin Mixture A was portioned into “Max 200” jars (FlackTek) and graphene was added on top. Samples were mixed as stated in Example 2. Sipernat D13 precipitated silica (Evonik) and calcium carbonate (Solvay) were added to their respective samples 2% at a time (based on Resin Mixture A) until a viscosity of near 9000 poise (not measured) was reached. Samples were mixed for 35 seconds between each addition. All amounts are listed in Table 4. Samples were allowed to cool to room temperature before manganese dioxide accelerator was added and the samples were mixed again as described in Example 2. Samples were immediately poured into Teflon molds with ⅛ inch thickness and cured at room temperature for two weeks. Cured pies were removed from the molds and resistivity measurements (Table 4) were made with a resistivity meter. Tensile and elongation measurements were made on an Instron 4443 (available from Instron).

TABLE 3
Components of Resin Mixture A.
Resin Mixture A

| Material | Amount (g) |
|---|---|
| Permapol P-3.1e | 591.24 |
| Permapol L56086 | 158.22 |
| HB-40 | 9.54 |
| DABCO 33LV | 4.97 |
| Tung Oil | 15.30 |

TABLE 4
Components of each sample and final properties of the cured pie.

| | Resin | Particles | Sipernat | Calcium | | Resistivity | | |
|---|---|---|---|---|---|---|---|---|
| | Mixture | from Example | D13 | Carbonate | MnO₂ | (ohms per | % | Tensile |
| Sample | A (g) | 1 (g) | (g) | (g) | (g) | square) | Elong. | (kPa) |
| 1 | 127.33 | 1.40 | 22.95 | 0 | 12.73 | 10⁸ | 491.52 | 3006.10 |
| 2 | 127.33 | 4.20 | 5.10 | 0 | 12.73 | 10⁵ | 459.43 | 2607.15 |
| 3 | 127.33 | 7.00 | 0 | 0 | 12.73 | 10⁴ | 429.32 | 2288.74 |
| 4 | 127.33 | 1.40 | 0 | 35.70 | 12.73 | 10⁸ | 442.99 | 2430.44 |
| 5 | 127.33 | 4.20 | 0 | 7.65 | 12.73 | 10⁶ | 415.38 | 2171.57 |
| 6 | 127.33 | 7.00 | 0 | 0 | 12.73 | 10⁴ | 433.07 | 2159.40 |

### Example 4

Resin Mixture A was prepared first to be used in all experiments in this example. All materials (listed in Table 5) were combined as stated in Example 2. Resin Mixture A was portioned into “Max 100” jars (FlackTek) and graphene and carbon black REGAL® 660R (from Cabot Blacks) were added on top. Samples were mixed as stated in Example 2. All amounts are listed in Table 6. Samples were allowed to cool to room temperature before manganese dioxide accelerator was added and the samples were mixed again as described in Example 2. Samples were immediately poured into Teflon molds with ⅛ inch thickness and cured at room temperature for two weeks. Cured pies were removed from the molds and resistivity measurements (Table 6) were made with a resistivity meter.

TABLE 5
Components of Resin Mixture A.
Resin Mixture A

| Material | Amount (g) |
|---|---|
| Permapol P-3.1e | 305.47 |
| Permapol L56086 | 81.75 |
| HB-40 | 4.93 |
| DABCO 33LV | 2.57 |
| Tung Oil | 7.91 |
| Particles from Example 1 | 13.30 |

TABLE 6
Components of each sample and final properties of the cured pie.

| | Resin | Carbon | Mn Accelerator | Resistivity |
|---|---|---|---|---|
| | Mixture | Black | #5408 | (ohms per |
| Sample | A (g) | (g) | (g) | square) |
| 1 | 75.00 | 0.00 | 7.50 | 10⁷ |
| 2 | 75.00 | 2.48 | 7.50 | 10⁵ |
| 3 | 75.00 | 4.13 | 7.50 | 10⁶ |
| 4 | 75.00 | 6.19 | 7.50 | 10⁵ |
| 5 | 75.00 | 8.25 | 7.50 | 10⁵ |

Whereas particular embodiments of this invention have been described above for purposes of illustration, it will be evident to those skilled in the art that numerous variations of the details of the present invention may be made without departing from the invention as defined in the appended claims.

What is claimed is:

1. A composition comprising:
(a) a sulfur-containing polymer comprising at least one of a polysulfide and a polythioether, wherein the sulfur-containing polymer is present in an amount of at least 30 percent by weight, based on the total weight of non-volatile components in the composition; and
(b) graphenic carbon particles.

2. The composition of claim 1, wherein the sulfur-containing polymer comprises a polythioether comprising a structure having the formula:
—R¹—[—S—(CH₂)₂—O—[—R²—O—]ₘ—(CH₂)₂—S—R¹]ₙ—
wherein:
(1) R¹ denotes a C₂₋₆ n-alkylene, C₃₋₆ branched alkylene, C₆₋₈ cycloalkylene or C₆₋₁₀ alkylcycloalkylene group, —[(—CH₂—)ₚ—X—]_{q}—(—CH₂—)ᵣ—, or —[(—CH₂—)ₚ—X—]_{q}—(—CH₂—)ᵣ— in which at least one —CH₂— unit is substituted with a methyl group;
(2) R² denotes a C₂₋₆ n-alkylene, C₂₋₆ branched alkylene, C₆₋₈ cycloalkylene or C₆₋₄₀ alkylcycloalkylene group, or —[(—CH₂—)ₚ—X—]_{q}—(—CH₂—)ᵣ—, X denotes one selected from the group consisting of O, S and —NR⁶—, R⁶ denotes H or methyl;
(3) m is a rational number from 0 to 10;
(4) n is an integer from 1 to 60;
(5) p is an integer from 2 to 6;
(6) q is an integer from 1 to 5, and
(7) r is an integer from 2 to 10.

3. The composition of claim 1, wherein the graphenic carbon particles have a thickness, measured in a direction perpendicular to the carbon atom layers, of no more than 10 nanometers.

4. The composition of claim 3, wherein the thickness is no more than 5 nanometers.

5. The composition of claim 4, wherein the graphenic carbon particles have a width and length, measured in a direction parallel to the carbon atoms layers, of more than 100 nanometers.

6. The composition of claim 4, wherein the graphenic carbon particles have an oxygen content of no more than 1 atomic weight percent.

7. The composition of claim 1, wherein the graphenic carbon particles have bulk density of no more than 0.1 g/cm³.

8. The composition of claim 1, wherein the graphenic carbon particles have a compressed density of 0.9 g/cm³ or less.

9. The composition of claim 1, wherein a 0.5% by weight solution of the graphenic carbon particles in butyl cellosolve has a bulk liquid conductivity of at least 100 microSiemens as measured by a Fisher Scientific AB 30 conductivity meter.

10. The composition of claim 1, further comprising conductive carbon black.

11. A method of sealing an aperture comprising:
(a) applying the composition of claim 1 to one or more surfaces defining an aperture; and
(b) allowing the composition to cure to form a cured sealant.

12. A composition comprising:
(a) a sulfur-containing polymer; and
(b) graphenic carbon particles having a compressed density of no more than 0.9 g/cm³.

13. The composition of claim 12, wherein the sulfur-containing polymer comprises at least one of a polysulfide and a polythioether.

14. The composition of claim 13, wherein the sulfur-containing polymer is present in an amount of at least 30 percent by weight, based on the total weight of non-volatile components in the composition.

15. The composition of claim 14, wherein the graphenic carbon particles have a thickness, measured in a direction perpendicular to the carbon atom layers, of no more than 5 nanometers.

16. The composition of claim 15, wherein the graphenic carbon particles have an oxygen content of no more than 2 atomic weight percent.

17. The composition of claim 12, wherein the graphenic carbon particles have a bulk density of no more than 0.1 g/cm³.

18. The composition of claim 17, wherein the compressed density is less than 0.8 g/cm³.

19. The composition of claim 12, further comprising conductive carbon black.

20. A method of sealing an aperture comprising:
(a) applying the composition of claim 12 to one or more surfaces defining an aperture; and
(b) allowing the composition to cure to form a cured sealant.

21. A composition comprising:
(a) a sulfur-containing polymer; and
(b) graphenic carbon particles, wherein a 0.5% by weight solution of the graphenic carbon particles in butyl cellosolve has a bulk liquid conductivity of at least 100 microSiemens as measured by a Fisher Scientific AB 30 conductivity meter.

22. The composition of claim 21, wherein the sulfur-containing polymer comprises at least one of a polysulfide and a polythioether.

23. The composition of claim 22, wherein the sulfur-containing polymer is present in an amount of at least 30 percent by weight, based on the total weight of non-volatile components in the composition.

24. The composition of claim 21, wherein the graphenic carbon particles have a thickness, measured in a direction perpendicular to the carbon atom layers, of no more than 5 nanometers.

25. The composition of claim 21, wherein the graphenic carbon particles have a compressed density of 0.9 g/cm³ or less.
